(19) United States
(12) Patent Application Publication
(10) Pub. No.: US 2006/0130990 A1
(43) Pub. Date: Jun. 22, 2006

(54) Reactive silicone emulsions

(76) Inventors: Rachid Arfaoui, Geneva (CH); George A. Policello, Ossining, NY (US); Ian Procter, Bogis-Bossey (CH)

Correspondence Address: GEAM - SILICONES - 60SI;IP LEGAL, ONE PLASTICS AVENUE, PITTSFIELD, MA, 01201-3697, US

(21) Appl. No.: 11/017,959

(22) Filed: Dec. 21, 2004

(51) Int. Cl. C08L 83/04; D21F 11/00; D21H 23/00

(52) U.S. Cl. 162/158; 525/474; 524/588

(57) ABSTRACT

The present invention provides for a reactive silicone emulsion composition for softening tissue paper and other cellulosics comprising the reaction product of: a) a silanol fluid; b) an amino-alkoxy silane; c) a silane cross linker; d) a cationic emulsifier; e) a nonionic surfactant f) a Bronsted base and g) water wherein cellulosics softened with said composition undergoes no significant reduction in tensile strength. The invention further provides for a method of softening cellulosics and cellulosics softened with the compositions of the present invention.

### FIELD OF THE INVENTION

The present invention relates to reactive silicone emulsions. More particularly the present invention relates to reactive silicones that impart a benefit to paper and textiles. More particularly the benefit imparted to paper and textiles by the reactive silicone emulsions of the present invention is an improved softness to the feel of the paper or textile without adversely affecting the tensile strength of the paper or textile.

### BACKGROUND OF THE INVENTION

Treatment of tissue paper with high molecular weight silicones improves the softness of the tissue paper. This improvement in softness has invariably been accompanied by a reduction in the tensile strength of the tissue paper. While organic compounds can be used to impart an improved softening to tissue paper without the adverse effect on tensile strength seen using silicones, the improvement in softness is much less than that achieved by using silicones.

The antagonistic effects on softening and tensile strength seen with the use of silicone softening agents for tissue paper are illustrated by U.S. Pat. No. 5,389,204, where the effects of a silicone surfactant material used to enhance softness and control wettability are offset by the addition of a binder, e.g. starch, to contribute tensile strength and control linting. The use of starch and similar materials to increase the tensile strength of paper and to control Tinting is described in U.S. Pat. No. 4,959,125. More recently, U.S. Pat. No. 5,397,435 describes the use of both a wet strength binder and a dry strength binder to improve the tensile strength of multi-ply tissue paper when silicone softening agents are used to impart softness to paper. In contrast to methods of treating paper to improve softness once the paper is manufactured, U.S. Pat. No. 5,275,698 describes a manufacturing process to produce a softer paper.

### SUMMARY OF THE INVENTION

The present invention provides for a reactive silicone emulsion composition for softening tissue paper and other cellulosics comprising the reaction product of:
a) a silanol fluid;
b) an amino-alkoxy silane;
c) a silane cross linker;
d) a cationic emulsifier;
e) a nonionic surfactant
f) a Bronsted base and
g) water
   wherein cellulosics softened with said composition undergoes no significant reduction in tensile strength. The present invention further provides for a method of softening cellulosics and cellulosics softened with the compositions of the present invention.

### DETAILED DESCRIPTION OF THE INVENTION

The present invention describes a reactive silicone emulsion composition that softens woven textiles, non-woven textiles and paper without loss of tensile strength. The composition of the reactive silicone emulsion comprises the reaction product of:
a) a silanol fluid having the formula MₐM_{b}D_{c}D_{d}TₑT_{f}Q_{g};
   where
   Mₐ=R¹R²R³SiO_{1/2};
   M_{b}=R⁴R⁵R⁶SiO_{1/2};
   D_{c}=R⁷R⁸SiO_{2/2};
   D_{d}=R⁹R¹⁰SiO_{2/2};
   Tₑ=R¹¹SiO_{3/2};
   T_{f}=R¹²SiO_{3/2};
   Q_{g}=SiO_{4/2}
   where R¹, R⁷ and R¹¹ are independently selected from the group consisting of OH and OR¹³; R², R³, R⁴ , R⁵, R⁶, R⁸ , R⁹, R¹⁰, R¹², and R¹³ are each independently selected from the group consisting of one to six carbon monovalent hydrocarbon radicals;
   where the subscripts a, b, c, d, e, f, and g are zero or positive integers for molecules subject to the following relationships:
   (a+b)=2+e+f+2(c+d);
   2≦(d+c)≦100;
   0≦(e+f)≦3;
   0<g<2
   with the requirement that a+c+e≧2;

b) an amino-alkoxy silane having the formula:
(R¹⁴O)₃₋ₕSi(R¹⁵JN(R¹⁶)₂₋ᵢ(JNR¹⁷₂)ᵢ)ₕ
with the subscripts h and i defined as follows:
0≦h≦2 and 0≦i≦2
where R¹⁴ and R¹⁵, are each independently selected from the group consisting of one to six carbon monovalent hydrocarbon radicals; J is an alkylene bridging group having from one to eight carbon atoms (i.e. a divalent hydrocarbon radical having from one to eight carbon atoms), and R¹⁶ and R¹⁷ are each are each independently selected from the group consisting of one to six carbon monovalent hydrocarbon radicals and Z where
Z=JSi(R¹⁸)j(OR¹⁹)₃₋ⱼ with 0≦j≦2; or
the reaction product of an amino-alkoxy silane as herein defined having the formula:
(R14O)₃₋ₕSi(R¹⁵JN(R¹⁶)₂₋ᵢ(JNR¹⁷₂)ᵢ)ₕ
with water;

c) a silane cross linker having the formula:
(R¹⁸O)₄₋ₖ₋ₘSi(G)ₖWₘ
where k is 0 or 1 and 0≦m≦2

G is selected from the group consisting of R¹⁹, A, —CH₂—CH₂(C₆H₉(O)), a monovalent radical derived from 4-vinyl-1-cyclohexene 1,2-epoxide, and —CH₂—CH₂—CH₂—O—CH₂—CH(O)CH₂, a monovalent radical derived from allyl glycidyl ether;

A is J¹N(R²⁰)₂₋ₙ(J¹NR²¹₂)ₙ with each J¹ an alkylene bridging group having from one to eight carbon atoms and 0≦n≦2;

W is J²Si(L)ₚ(OR²¹)₃₋ₚ with each J² an alkylene bridging group having from one to eight carbon atoms and 0≦p≦2; and

L is selected from the group consisting of R²²,

—CH₂—CH₂—CH₂—O—CH₂—CH(O)CH₂, and —CH₂—CH₂(C₆H₉(O)) with each R¹⁸, R¹⁹, R²⁰, R²¹, and R²² independently selected from the group consisting of one to six carbon monovalent hydrocarbon radicals; or

the reaction product of an amino-alkoxy silane having the formula:
(R¹⁴O)₃₋ₕSi(R¹⁵JN(R¹⁶)₂₋ᵢ(JNR¹⁷₂)ᵢ)ₕ as herein defined with water;

d) a cationic emulsifying agent selected from the group consisting of quaternary alkyl ammonium compounds;

e) a nonionic surfactant selected from the group of
i) nonionic surfactants having a hydrophilic-lipophilic balance (HLB) ratio ranging from about 5 to about 15 and
ii) an organosilicone polyether copolymer,
iii) and mixtures thereof;

f) a Bronsted base preferably selected from the group consisting of sodium hydroxide, potassium hydroxide, and tetra-alkyl ammonium hydroxide; and

g) water.

Component a), the silanol fluid, is present in amounts ranging from about 2 weight percent to about 60 weight percent; preferably from about 10 weight percent to about 50 weight percent; more preferably from about 15 weight percent to about 40 weight percent; and most preferably from about 20 weight percent to about 40 weight percent.

Component b), the amino-alkoxy silane, is present in amounts ranging from slightly greater than 0 weight percent to about 1.5 weight percent; preferably slightly greater than 0 weight percent to about 1 weight percent; more preferably slightly greater than 0 weight percent to about 0.75 weight percent; and most preferably from about slightly greater than 0 weight percent to about 0.3 weight percent.

Component c), the silane cross linker, is present in amounts ranging from about 0.05 weight percent to about 5.0 weight percent; preferably from about 0.05 weight percent to about 3.0 weight percent; more preferably from about 0.1 weight percent to about 2.5 weight percent; and most preferably from about 0.1 weight percent to about 1.0 weight percent.

Component d), the cationic emulsifying agent, is present in amounts ranging from about 0.2 weight percent to about 15.0 weight percent; preferably from about 0.5 weight percent to about 10.0 weight percent; more preferably from about 0.5 weight percent to about 7.5 weight percent; and most preferably from about 0.5 weight percent to about 5.0 weight percent. Exemplary alkyl quaternary ammonium compounds, the cationic emulsifying agent, include but are not limited to: trimethyltallow ammonium chloride, trimethylcoco ammonium bromide, trimethyl alkyl, dimethyl dialkyl, or methyl trialkyl ammonium halides, sulfates, carboxylates and phosphates.

Component e), the nonionic surfactant, is present in amounts ranging from about 0.2 weight percent to about 15.0 weight percent; preferably from about 0.5 weight percent to about 10.0 weight percent; more preferably from about 0.5 weight percent to about 7.5 weight percent; and most preferably from about 0.5 weight percent to about 5.0 weight percent. Exemplary nonionic surfactants include but are not limited to: ethoxylated secondary alcohol from Dow Chemicals such as Tergitol 15-S-3 (HLB=8), Tergitol 15-S-7 (HLB=12.1), Tergitol 15-S-9 (HLB=13.3), Tergitol TMN 6 (HLB=11.7), Tergitol TMN 10 (HLB=14.1) ethoxylated primary alcohol from Dow Chemicals such Tergitol® 25 L 3 (HLB=7.5), Tergitol 25 L 5 (HLB=10.4), Tergitol 25 L 7 (HLB=12.4), Tergitol 25 L 9 (HLB=12.8), Tergitol 25 L 12 (HLB=14.2), ethylene oxide/propylene oxide block polymer from BASF such as Pluronic® PE 10100, Pluronic PE 3100, Pluronic PE 4300, Pluronic PE 6100, Pluronic PE 6200, Pluronic PE 6400, Pluronic PE 6800, Pluronic PE 8100, Pluronic PE 9200, Pluronic PE 9400, Pluronic RPE 3110.

Organosilicone polyether copolymers typically possess the structure:
X—Si(Me₂)O(Si(Me₂)O)ₓ(Si(Me)(X)O)_{y}Si(Me₂)X
wherein

X is an alkyl group of 1 to 4 carbons, or polyether of the general structure
R²³O(C₂H₄O)_{q}(C₃H₆O)ₛ(C₄H₈O)ₜR²⁴
where R²³ is a hydrocarbon radical of 2 to 6 carbons, either linear or branched. R²⁴ is H or a monovalent hydrocarbon radical of from one to six carbon atoms,
where

q is 4 to 100

s is 0 to 50

t is 0 to 50

x is 0 to 100;

y is 0 to 50 with the provision that when y is 0, X is polyether. One embodiment of X is represented by a polyether, where R²³=propyl, q=8, s=0, t=0 and R²⁴=methyl. Another embodiment of X is where R²³=propyl, q=20, s=8, t=3 and R²⁴═H. Non-limiting illustrative examples of X are:
CH₂CH₂CH₂—O—(CH₂CH₂—O)₈—H and
CH₂CH(CH₃)CH₂—O—(CH₂—CH(CH₃)—O)₁₂—CH₃

Component f), is present in amounts sufficient to make the pH of the composition range from about 9.5 to about 14; preferably from about 10 to about 14; more preferably from about 10 to about 12.5; and most preferably from about 10 to about 11.

Component g), the water, is present in an amount of about 25 weight percent to about 97 weight percent; preferably from about 25 weight percent to about 80 weight percent; more preferably from about 30 weight percent to about 75 weight percent; and most preferably from about 40 weight percent to about 65 weight percent.

For molecular species, the stoichiometric subscripts herein disclosed will be integral or zero; for mixtures of molecular species conforming to a particular disclosed formula, the subscripts will be molar averages and therefore possibly non-integral when not zero.

As is generally known, emulsions comprise at least two immiscible phases, one of which is continuous and the other, which is discontinuous. Further, emulsions may be liquids with varying viscosities comprising solids. Additionally, the particle size of the emulsions may render them microemulsions, and when sufficiently small, such microemulsions may be transparent. Further it is also possible to prepare emulsions of emulsions and these are generally known as multiple emulsions.

The primary types of aqueous emulsions may be either

1) aqueous emulsions where the discontinuous phase comprises water and the continuous phase comprises the alkoxy siloxane/silanes described in the present invention; or

2) aqueous emulsions where the discontinuous phase comprises the alkoxy siloxane/silanes of the present invention and the continuous phase comprises water.

The compositions of the present invention also tolerate optional ingredients such as (but not limited to):

a. propylene glycol or other glycols;

b. a neutralizing agents such as mineral acids e.g. hydrochloric acid, sulfuric acid, phosphoric acid, and carboxylic acids of 2 to 6 carbons, citric, succinnic acid glycolic acid;

c. biocides, e.g. Kathon® LXE (available from Rohm and Haas), Preventol® P-840 (available from Bayer), Proxel® GXL (available from Avecia Biocides); Liquapar® Optima (available from International Specialty Products; and

d. humectants, e.g. humectants derived from glycerin, or polyoxyethylene.

The composition of this present invention may be applied to tissue paper as is, with dilution or together with other treatments. Because tissue paper is cellulosic in nature and corresponds in structure to a felted fabric it is expected that the compositions of the present invention would impart benefits to cellulosic materials or materials that were like cellulosic materials and were disposed as sheets much like paper or textiles, e.g. cellulosic textiles. Thus the composition of the present invention may be applied as a finish not only to tissue paper but also paper towels, wipes, textiles and other substrates composed of viscose, cellulose, cotton, polyester, polypropylene, polyethylene, or mixtures thereof (cellulosics).

In treating tissue paper and other cellulosics, the compositions of the present invention impart softness to the cellulosic without any significant reduction in tensile strength of the cellulosic. The phrase any or no significant reduction in tensile strength also includes no reduction in tensile strength or an increase in tensile strength. The reduction in tensile strength is no more than about thirty (30) percent, preferably no more than about twenty (20) percent, more preferably no more than about ten (10) percent and most preferably no more than about five (5) percent.

The following examples are merely illustrative of the invention, serving to illustrate only some of the features of the present invention. The appended claims are intended to claim the invention as broadly as it has been conceived and the examples herein presented are illustrative of selected embodiments from a manifold of all possible embodiments. Accordingly it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims. All United States patents referenced herein are herewith and hereby specifically incorporated by reference.

Experimental

The tissue treatments were applied on to tissue in the laboratory using a Devilbiss hand operated spray gun (model JGA). Sufficient emulsion is evenly sprayed on both sides of a sheet of untreated tissue (hung vertically) to give the desired level emulsion. The quantity of emulsion is determined to give specified add-on level of tissue treatment. The quantity of treatment added is determined by weighing each piece of tissue before and after application, and the add-on level of active ingredients determined via the concentration of the material sprayed onto the tissue.

The treated wet tissue is then allowed to dry overnight by hanging at room temperature.

Alternatively, tissue treatments can be applied by commercially available spray, kiss roller or print techniques.

### EXAMPLE 1

The compositions of the present invention were prepared according to the procedure listed below.

Composition:

| | | Parts by weight |
|---|---|---|
| 1 | Silanol terminated | 35.0 |
| | polydimethylsilicone (visc = 100 cSt) | |
| 2 | N-(beta-aminoethyl)-gamma- | 0.6 |
| | aminopropyl trimethoxysilane | |
| 3 | Hexacecyltrimethylammonium | 4.30 |
| | chloride (29% aqu. sol.) | |
| 4 | C₁₂-C₁₅ secondary alcohol 15 mol | 5.50 |
| | ethoxylate | |
| 5 | Silwet L-7605 | 0.75 |
| | (organosilicone polyether | |
| | copolymer) | |
| 6 | NaOH (50% aqu sol.) | 0.42 |
| 7 | Water | 50.0 |
| 8 | Acetic Acid¹ | Q.S. pH = 6.5 |
| 9 | Propylene Glycol | 0.75 |
| 10 | Liquapar Optima² | 0.40 |
| 11 | Final Water³ | Q.S. 100 |

¹Quantity sufficient to achieve pH = 6.5 (approximately 0.3%)
²Supplied by International Specialty Products, Wayne, New Jersey, USA
³Quantity sufficient to achieve 100%

Procedure:
1) blend components 1 and 2 to give a homogeneous blend.
2) make an emulsion of the above blend with components 3, 4, 5, 6, & 7.
3) in a closed container, heat the emulsion to 50° C. and maintain at 50° C. for 24 hours.
4) cool the emulsion to 25° C. and neutralize with acetic acid (8) to give a pH of 6.5.
5) blend into the emulsion a mixture of components 9 and 10.
6) add final water (component 11)

### EXAMPLE 2

Table 1 provides a description of the Reactive Silicone Emulsion (RSE) of the present invention, as well as comparative silicone emulsions used as tissue finishes in the following examples.

TABLE 1
Silicone Tissue Finishes

| | Composition | |
|---|---|---|
| Silicone | of Invention | Description |
| RSE-1 | Yes | A Reactive Silicone Emulsion, |
| | | containing a crosslinked reactive |
| | | aminosilicone fluid (as described |
| | | in example 1) |
| Silicone | No | An emulsion prepared using 50% |
| Emulsion A | (Comparative) | of a blend of aminosilicone fluids |
| | | (CAS # 71750-79-3) and |
| | | isopropylmyristate (CAS # 110- |
| | | 27-0). The emulsion is prepared |
| | | with a nonionic emulsification |
| | | system. |
| Silicone | No | An emulsion prepared by |
| Emulsion B | (Comparative) | emulsion condensation, yielding |
| | | an emulsion containing a linear |
| | | reactive aminosilicone fluid. |

### EXAMPLE 3

Several silicone finishes were applied to tissue using a hand spray applicator (described above), without stretching the tissue (converting), yielding tissue containing 0.5% of non-volatile materials based upon the weight of the substrate. The tissue was air dried at ambient temperatures overnight.

Tensile strength was determined using mechanical testing with a Zwick-1445 and Zwick PC-Software 27005. Test conditions were:
break detection: 80%
sect-80: 7.20 mm²
digital gauge length: 190 mm

Softness was determined by a hand panel where softness was rated on a scale of 1 to 10, where 1 is harsh and 10 is soft.

Table 2 demonstrates that tissue treated with the compositions of the invention provide an improvement in softening and tensile strength relative to the conventional aminosilicone emulsion.

TABLE 2
The Effect of Silicone Finish on the Tensile Strength
and Softness of Tissue

| | | | Tensile | |
|---|---|---|---|---|
| | | | Strength | Softness |
| | Add on | Tensile Strength | (machine | (Panel |
| | (%)^{a} | (cross direction) | direction) | Test) |
| Untreated tissue | NA | 3.9 N | 8.8 N | 3 |
| Water Only Treatment | NA | 3.5 N | 7.2 N | 2 |
| RSE-1 | 0.5% | 5.1 N | 11.3 N | 6.5 |
| Silicone Emulsion A | 0.5% | 3.3 N | 7.3 N | 6.5 |
| Silicone Emulsion B | 0.5% | 4.1 N | 9.6 N | 8 |

^{a}Percent finish “Add-on” by weight of substrate.

### EXAMPLE 4

Several silicone finishes were applied to tissue using a kiss-roller application method to give 0.5% “add-on” of the non-volatile material of the tissue treatment based on weight of substrate. Rolls of tissue were left to condition before testing.

Tensile strength was determined using mechanical testing with a Zwick-1445 and Zwick PC- Software 27005. Test conditions were:
break detection: 80%
sect-80: 7.20 mm²
digital gauge length: 190 mm

Softness was determined by hand panel where softness was rated on a scale of 1 to 10, where 1 is harsh and 10 is soft.

Table 3 demonstrates that tissue treated with the composition of the invention provides an improvement in softening and tensile strength relative to the conventional aminosilicone emulsion.

TABLE 3
The Effect of Silicone Finish on the Tensile Strength
and Softness of Tissue

| | | | Tensile | |
|---|---|---|---|---|
| | | | Strength | Softness |
| | Add on | Tensile Strength | (machine | (Panel |
| Tissue treatment | (%)^{a} | (cross direction) | direction) | Test) |
| Untreated | NA | 3.6 N | 8.1 N | 3 |
| RSE-1 | 0.5% | 4.0 N | 8.5 N | 7 |
| Silicone Emulsion A | 0.5% | 2.5 N | 5.6 N | 7 |
| Silicone Emulsion B | 0.5% | 3.9 N | 7.8 N | 7.5 |

^{a}Percent finish “Add-on” by weight of substrate.

Having described the invention that which is claimed is:

1. A reactive silicone emulsion composition for softening tissue paper comprising the reaction product of:
a) a silanol fluid;
b) an amino-alkoxy silane;
c) a silane cross linker;
d) a cationic emulsifier;
e) a nonionic surfactant
f) a Bronsted base and
g) water
wherein tissue paper softened with said composition undergoes no significant reduction in tensile strength.

2. The composition of claim 1 wherein the silanol fluid has the formula:
MₐM_{b}D_{c}D_{d}TₑT_{f}Q_{g};
where
Mₐ=R¹R²R³SiO_{1/2};
M_{b}=R⁴R⁵R⁶SiO_{1/2};
D_{c}=R⁷R⁸SiO_{2/2};
D_{d}=R⁹R¹⁰SiO_{2/2};
Tₑ=R¹¹SiO_{3/2};
T_{f}=R¹²SiO_{3/2};
Q_{g}=SiO_{4/2}
where R¹, R⁷ and R¹¹ are independently selected from the group consisting of OH and OR¹³; R², R³, R⁴ , R⁵, R⁶, R⁸ , R⁹, R¹⁰, R¹², and R¹³ are each independently selected from the group consisting of one to six carbon monovalent hydrocarbon radicals;
where the subscripts a, b, c, d, e, f, and g are zero or positive integers for molecules subject to the following relationships:
(a+b)=2+e+f+2(c+d);
2≦(d+c)≦100;
0≦(e+f)≦3;
0≦g≦2
with the requirement that a+c+e≧2.

3. The composition of claim 2 wherein the amino-alkoxy silane has the formula:
(R¹⁴O)₃₋ₕSi(R¹⁵JN(R¹⁶)₂₋ᵢ(JNR¹⁷₂)ᵢ)ₕ
with the subscripts h and i defined as follows:
0≦h≦2 and 0≦i≦2
where R¹⁴ and R¹⁵, are each independently selected from the group consisting of one to six carbon monovalent hydrocarbon radicals; J is an alkylene bridging group having from one to eight carbon atoms (i.e. a divalent hydrocarbon radical having from one to eight carbon atoms), and R16 and R¹⁷ are each are each independently selected from the group consisting of one to six carbon monovalent hydrocarbon radicals and Z where
Z=JSi(R¹⁸)j(OR¹⁹)₃₋ⱼ with 0≦j≦2; or
the reaction product of an amino-alkoxy silane as herein defined having the formula:
(R¹⁴O)₃₋ₕSi(R¹⁵JN(R¹⁶)₂₋ᵢJNR¹⁷₂)ᵢ)ₕ
with water.

4. The composition of claim 3 wherein the silane cross linker has the formula:
(R¹⁸O)₄₋ₖ₋ₘSi(G)ₖWₘ
where k is 0 or 1 and 0≦m≦2
G is selected from the group consisting of R¹⁹, A, —CH₂—CH₂(C₆H₉(O)), and —CH₂—CH₂—CH₂—O—CH₂—CH(O)CH₂.

5. The composition of claim 4 wherein the cationic emulsifier is selected from the group consisting of quaternary alkyl ammonium compounds.

6. The composition of claim 5 wherein the nonionic surfactant is selected from the group consisting of:
a) surfactants having a hydrophilic-lipophilic balance (HLB) ratio ranging from about 5 to about 15
b) an organosilicone polyether copolymer, and
c) mixtures thereof.

7. The composition of claim 6 wherein the Bronsted base is selected from the group consisting of sodium hydroxide, potassium hydroxide, and tetra-alkyl ammonium hydroxide.

8. The composition of claim 7 wherein the amount of the silanol fluid ranges from about 2 weight percent to about 60 weight percent.

9. The composition of claim 8 wherein the amount of the amino-alkoxy silane ranges from slightly greater than 0 weight percent to about 1.5 weight percent.

10. The composition of claim 9 wherein the amount of silane cross linker ranges from about 0.05 weight percent to about 5.0 weight percent.

11. The composition of claim 10 wherein the amount of cationic emulsifier ranges from about 0.2 weight percent to about 15.0 weight percent.

12. The composition of claim 11 wherein the amount of nonionic surfactant ranges from 0.2 weight percent to about 15.0 weight percent.

13. The composition of claim 12 wherein the amount of Bronsted base is present in an amount sufficient to make the pH of the composition range from about 9.5 to about 14.

14. A method for softening cellulosics comprising applying the composition of claim 1 to said celluslosic.

15. A method for softening cellulosics comprising applying the composition of claim 2 to said celluslosic.

16. A method for softening cellulosics comprising applying the composition of claim 4 to said celluslosic.

17. A method for softening cellulosics comprising applying the composition of claim 13 to said celluslosic.

18. A cellulosic softened by the application of the composition of claim 1.

19. A cellulosic softened by the application of the composition of claim 4.

20. A cellulosic softened by the application of the composition of claim 13.
